(19) United States
(12) Patent Application Publication
(10) Pub. No.: US 2006/0095652 A1
(43) Pub. Date: May 4, 2006

(54) Memory device and method for receiving instruction data

(76) Inventor: Hermann Ruckerbauer, Moos (DE)

Correspondence Address: PATTERSON & SHERIDAN, LLP;Gero McClellan / Infineon Technologies, 3040 POST OAK BLVD.,, SUITE 1500, HOUSTON, TX, 77056, US

(21) Appl. No.: 10/977,462

(22) Filed: Oct. 29, 2004

(51) Int. Cl. G06F 12/00

(52) U.S. Cl. 711/105; 711/167

(57) ABSTRACT

Memory device and method for receiving instruction data. One embodiment provides a memory device including a memory array, an instruction unit for receiving an instruction data and for performing a memory related operation depending on the instruction data, address and command inputs for receiving a set of instruction signals, a reception unit which is adapted to receive sets of instruction signals during successive cycles, and a command assembling unit which is adapted to generate a first type instruction data from the set of instruction signals received in a first cycle and to generate a second type instruction data from the sets of instruction signals received in the first and second cycles, depending on the set of instruction signals received in the first cycle, and to provide the first type instruction data and the second type instruction data to the instruction unit.

### BACKGROUND OF THE INVENTION

1. Field of the Invention

The present invention is related to a memory device to which instruction data are supplied. The present invention is further related to a method for providing the instruction data to a memory device.

2. Description of the Related Art

A memory device usually includes a memory array for performing a memory-related operation depending on instruction data. The instruction data are received via address and command inputs which are adapted to receive a set of instruction signals indicating the instruction data.

In conventional memory devices and memory modules, the command and address information is supplied via a Fly-By bus which connects a memory controller to each of the memory devices of a memory module. This means that all instruction signals are provided by the memory controller simultaneously and are therefore simultaneously applied to each of the memory devices.

To initiate a memory-related operation, different types of instruction data, wherein the instruction data can be applied to the memory devices via a different number of instruction signals, may be simultaneously applied. For instance, in a DRAM memory device, a pre-charge command requires an 11 bit instruction signal, a column activation command (CAS) a 22 bit instruction signal and a row activation command (RAS) a 26 bit instruction signal. In order to transfer the instruction data indicating a row activation command, the address and command line connecting the memory controller and the memory devices has a width of 26 bit. When transferring a pre-charge command, only 11 bits (i.e., 11 address and command lines) are required. The transfer of the instruction data via 26 address and command lines therefore provides an inefficient way to supply the instruction data.

As in a conventional DRAM memory device, all 26 address and command lines are routed to all of the DRAM memory devices. The pincount of the memory controller and of the memory device is increased, thereby limiting the possible bandwidth of the address and command lines.

One aspect of the present invention is to increase the efficiency of the supplying of instruction data to a memory device, particularly to increase the bandwidth of the address and command lines.

### SUMMARY OF THE INVENTION

According to a first aspect, a memory device is provided including a memory array, an instruction unit for receiving instruction data and for performing a memory related operation depending on the instruction data and address and command inputs for receiving a set of instruction signals. During successive cycles, sets of instruction signals can be received by a reception unit. A command assembling unit is adapted to generate a first type instruction data from a set of instruction signals received in a first single cycle and to generate a second type instruction data from the sets of instruction signals received in the first and the second cycles, depending on the set of instruction signals received in the cycles. The command assembling unit further provides the first type instruction data and the second type instruction data to the instruction unit, respectively.

The memory device according to the first aspect of the present invention allows for distinguishing between first type instruction data and second type instruction data, wherein the first type instruction data is defined as instruction data which can be transferred in a single cycle and wherein the second type instruction data are to be transferred in more than one cycle. This classification allows for reducing the number of address and command inputs in each memory device. For example, instruction data indicating a column activation command or a row activation command can be divided up into two or more parts which are transferred successively to the memory device. In the memory device, the different parts of the instruction data are assembled to generate the instruction data provided to the instruction unit of the memory device to perform a memory-related operation. Thus, the pincount of the memory device and the address and command lines of the respective interconnection between the memory controller and the memory device can be reduced in number, and the bandwidth can be substantially increased. If a first type instruction data is received within a single cycle, it can be applied to the instruction unit without waiting for further instruction signals, and therefore, the instruction data can be provided with a lower power consumption. In cases where the data rate of the address and command bus is increased, the instruction data is supplied faster than in a prior art memory device.

According to another embodiment, the memory array is a dynamic random access memory or DRAM memory array having in a wordline-bitline matrix arranged memory cells, wherein the first type instruction data include a pre-charge instruction and wherein the second type instruction data include one of a row activation command and a column activation command. Furthermore, the address and command ports may be designed as differential inputs.

According to a further aspect of the present invention, a memory module is provided having a group of memory devices as mentioned above. Particularly, the memory module includes a first group of memory devices and a second group of memory devices, wherein the address and command inputs of the first group and of the second group are separately connectable via a module interface and an interconnection bus to the memory controller.

The memory module according to the further aspect of the invention, provides two groups of memory devices, each separately connected to one memory controller, wherein the command and bus lines of the interconnection bus are reduced in length and the number of memory devices connected to each of the address and command lines is reduced in comparison to a conventional memory module.

According to another aspect of the present invention, a method for supplying instruction data to a memory device is provided. An instruction data is received, and an operation related to the memory array is performed depending on the instruction data. The method includes the steps of receiving a first set of instruction signals in a first cycle and, depending on the first set of instruction signals received, either generating and providing a first type instruction data from the instruction signals received in the first cycle or receiving a second set of instruction signals in a successive cycle and generating and providing a second type instruction data from the sets of instruction signals received in the first and the successive cycles.

The method according to one embodiment of the present invention provides the possibility to reduce the number of address and command lines of the address and command bus between the memory controller and the memory device and reduces the pincount of the memory device as well as the pincount of the memory controller. The bandwidth can be increased since the driver capability of the address and command outputs of the memory controller can be increased as a reduced number of output drivers have to be operated in the memory controller.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a memory device according to a first embodiment of the present invention;

FIG. 2 is a memory module according to another embodiment of the present invention; and

FIGS. 3A and 3B show signal time diagrams of a conventional DRAM memory device and the memory device of FIG. 1.

### DETAILED DESCRIPTION OF THE PREFERRED EMBODIMENT

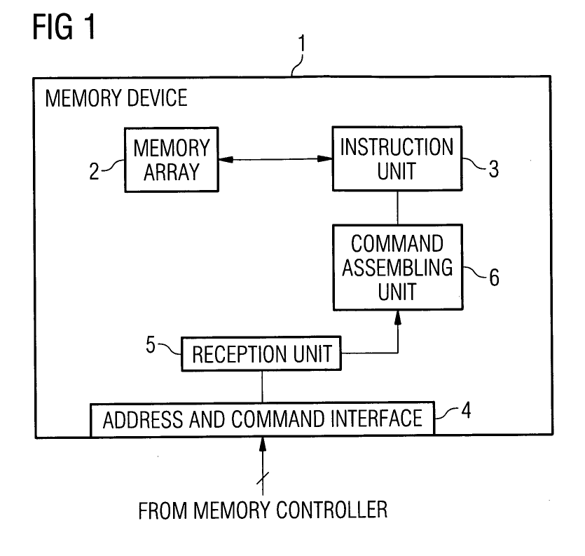

In FIG. 1, a block diagram of a memory device according to an embodiment of the present invention is depicted. The memory device 1 includes a memory array 2 comprising memory cells (not shown). The memory cells are preferably DRAM cells but can also be designed as other types of memory cells, such as SRAM cells and the like. The memory cells are arranged in a matrix formed by word-lines and bit-lines which are addressed and controlled by an instruction unit 3 operating the memory matrix according to instructions received.

The instructions according to which the performing of a memory-related operation in the memory array 2 is controlled are received via an address and command interface 4 having a number of address and command inputs. The address and command interface is, e.g., in a conventional computer system, connected to a memory controller (not depicted) which provides the instruction data supplied to the memory device 1. The memory controller transfers the instruction in the form of a set of instruction signals simultaneously transmitted to the address and command interface 4. The set of instruction signals is supplied to a reception unit 5 where the instruction signals are buffered and provided to a command-assembling unit 6 which is adapted to generate the instruction data.

The command assembling unit 6 has the following function. If in a first cycle a set of instruction signals is received, the command-assembling unit 6 analyzes the instruction signals received in the first cycle and depending on the received instruction signals generates a first-type instruction data. The first type instruction data is then provided to the instruction unit 3. If the received set of instruction signals indicates that the instruction data cannot be generated by the instruction signals of the first cycle, because the instruction signals are incomplete to generate a valid instruction data thereof, the instruction signals of a next cycle are received, and a second-type instruction data is generated using the set of instruction signals of the first cycle and the set of instruction signals of the successive cycle(s).

One aspect of the present invention is that given a set of instructions to perform a memory-related operation, the instructions usually are coded by a different number of bits transferred via the address and command lines of the address and command bus to supply the instruction from the memory controller to the memory device 1. For instance in a DRAM memory device, the different instructions may include a pre-charge command, a row activation command and a column activation command. For example, the pre-charge command is coded by 11 address and command bits, the column activation command by 22 address and command bits, and the row activation command by 26 address and command bits.

In a conventional memory device, all these bits indicating the respective instruction are transferred simultaneously to the memory device 1 so that the memory device can perform the memory-related operation just after reception of the set of instruction signals of one cycle. As the row activation command has to be transferred via 26 address and command lines, the address and command bus has a width of 26 address and command lines. If a pre-charge command has to be transferred via the address and command lines to the memory device 1, only 11 address and command bits are used, and therefore 15 address and command lines remain unused, resulting in the pre-charge command being transferred to the memory devices in an inefficient way.

A memory device according to one embodiment of the present invention allows for distinguishing between first type instructions and second type instructions wherein the first type instructions can be indicated by instruction signals with a bit count lower than a predetermined number and the second type instructions are indicated by instruction data having a bit count of more than the predetermined number. In the example given above, the predetermined number may be 13 so that the pre-charge command having 11 address and command bits is a first type instruction and the column activation command and the row activation command having 22 address and command bits and 26 address and command bits, respectively, are a second type instruction. While the instruction signals indicating a first type instruction are transferred in one cycle, the instruction signals of the second type instruction are transferred in two or more cycles wherein the second type instruction data is generated by assembling (combining) the set of instruction signals of successive cycles. Thereby, the number of address and command lines between the memory controller and the memory device 1 may be reduced to one half in the above-given example, such that the 26 address and command lines of the conventional memory device can be reduced to 13 address and command lines for the memory device according to one embodiment of the present invention. This allows an increase of the bandwidth of the memory controller output drivers which can drive the instruction signals with a higher rate when the overall power consumption of the memory controller is fixedly determined.

The bandwidth of the interconnection between the memory device 1 and the memory controller can be further increased by providing differential address and command lines between differential address and command inputs of the memory device 1 and a differential address and command output of the memory controller. Transmitting signals as a differential signal on differential lines allows a substantially increase of the data rate by which signals can be driven over an interconnection. Thus, regarding the above-given example of a memory device having 26 address and command inputs, the address and command lines can be used as differential signal lines to transmit 13 instruction signals with an increased data rate. In one embodiment, the data rate is doubled so that the amount of instruction data transferred in one unit of time is maintained.

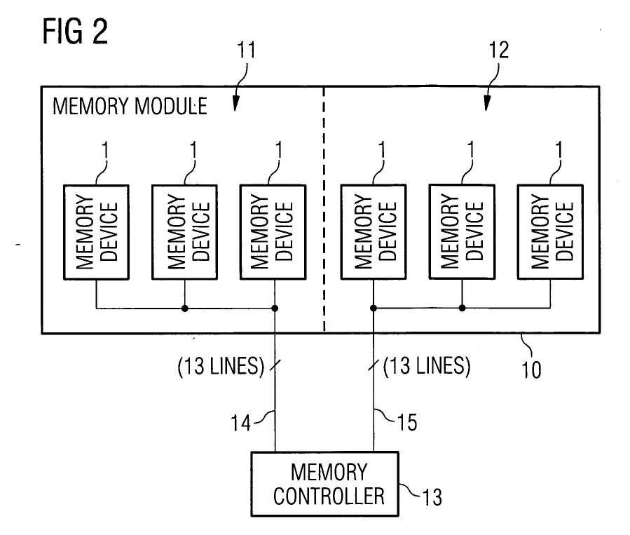

FIG. 2 shows a memory module 10 including, for example, six memory devices 1 divided up into two separate groups, wherein the first group 11 of memory devices is arranged at the left portion of the depicted memory module 10 and the second group 12 of memory devices 1 is shown as the right part of the memory module 10 in FIG. 2. Each of the memory devices 1 is connected to a memory controller 13 via address and command lines. The memory devices 1 of the first group 11 are connected to the memory controller 13 via the address and command lines of a first address and command bus 14, and the second group 12 of memory devices 1 are connected to the memory controller 13 via the address and command lines of the second address and command bus 15. Each of the address and command buses is configured as a Fly-By bus so that each line extends from the memory controller 13 to each of the memory devices of the respective group 11, 12. By decreasing the memory devices 1 connected to each of the address and command lines, the overall load of each line can be reduced, and the bandwidth and therefore the data rate for transmitting instruction signals can be increased.

In the example shown in FIG. 2, the address and command lines for each of the groups 11, 12 include 13 address and command lines so that the overall pincount of the memory controller 13 reserved for instruction signals to the memory devices 1 is maintained.

While accessing the memory array by providing a sequence of instruction data, first type instruction data and second type instruction data are normally sent. For instance, if the data rate for transmitting the address and command signals is doubled, the speed of providing instruction data to the memory devices is maintained for the second type instructions but is doubled for the transmission of the first type instructions, as the corresponding instruction data can be supplied to the instruction unit 3 one cycle earlier.

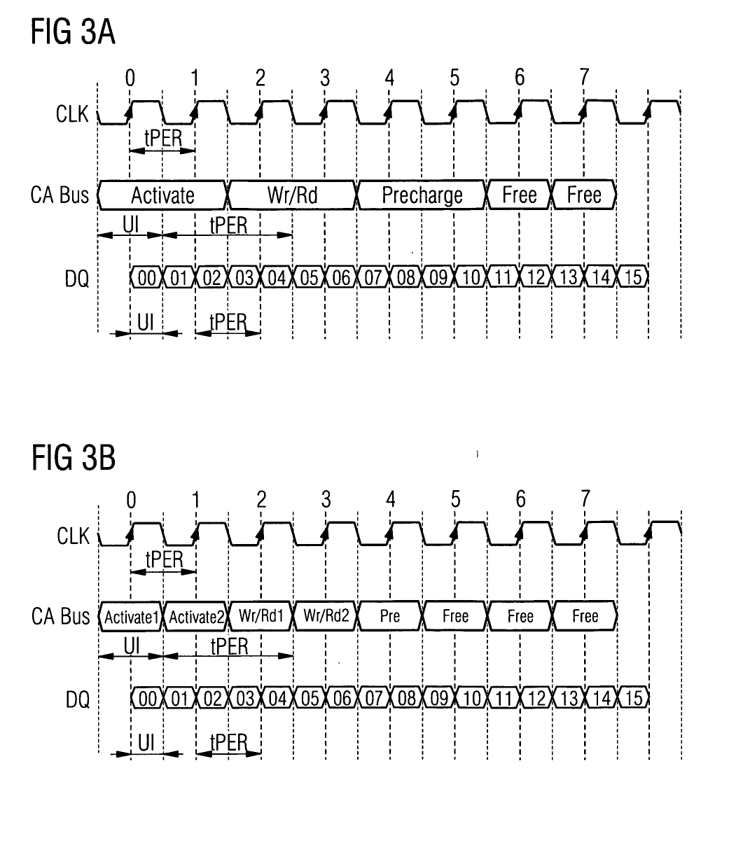

In FIGS. 3A and 3B, signal timing diagrams are depicted showing the relation of the clock signal CLK and the representative of the instruction signals CA for an instruction data sequence as row activation, column activation and pre-charge according to a prior art memory device and a memory device according to one embodiment of the present invention. The clock counts in the given example are numbered from 0 to 7. Data output DQ is depicted in relation to the clock count. In FIG. 3A, each of the address and command signals has to be applied for the time period of two clock periods of the respective inputs so that it can reliably be latched into the memory device. Consequently, all of the instruction data are applied after the clock count 5 after which data can be read out or written in according to the instruction data sequence.

In FIG. 3B, a signal timing diagram for the memory device according to one embodiment of the present invention is shown. It is assumed that the data rate is doubled. As can be seen (with regard to FIG. 3B), the row activation command is sent by two sets of instruction signals (ACTIVATE_1, ACTIVATE_2) which are latched in the clock cycles 0 and 1. After latching the ACTIVATE_2 signal, the row activation command is assembled and provided to the instruction unit. The same is true for the instruction signals received with the clock cycles 2 and 3 which are assembled to the column activation command provided to the instruction unit 3. As the pre-charge command is a first type instruction, it can be transmitted in one single cycle in the given example in cycle 4. Therefore, the pre-charge instruction can be supplied after cycle 4 to the instruction unit 3 and the performing of the pre-charge can be started in the memory array.

In contrast, in the conventional memory device, the pre-charge command needs the cycles 4 and 5 to be transferred to the memory device so that the pre-charge would start after clock cycle 5, and therefore, the whole instruction sequence is delayed as compared to the instruction sequence of the memory device 1 according to the present invention. Provided that the data rate has been increased by the factor 2, the whole sequence may be accelerated by about 16% compared to a conventional memory device.

While the foregoing is directed to embodiments of the present invention, other and further embodiments of the invention may be devised without departing from the basic scope thereof, and the scope thereof is determined by the claims that follow.

What is claimed is:

1. A memory device, comprising:
a memory array;
an instruction unit for receiving instruction data and performing a memory related operation depending on the instruction data;
address and command inputs for receiving instruction signals;
a reception unit adapted to receive sets of instruction signals in successive clock cycles; and
a command assembling unit adapted to selectively generate a first type instruction data from a single set of instruction signals received in a single clock cycle and a second type instruction data from a plurality of sets of instruction signals received in a corresponding plurality of successive clock cycles and to provide the first type instruction data and the second type instruction data to the instruction unit.

2. The memory device of claim 1, wherein the memory array is a DRAM memory array arranged in a word-line/bit-line matrix and wherein the first type instruction data includes a pre-charge instruction and wherein the second type instruction data includes one of a word line activation command and a bit line activation command.

3. The memory device of claim 1, wherein the address and command inputs comprise differential inputs.

4. The memory device of claim 1, wherein the command assembling unit is configured to generate the first type instruction data when a bit count of the received set of instruction signals is less than a predetermined number.

5. The memory device of claim 4, wherein the predetermined number corresponds to a number of address and command lines from a memory controller.

6. The memory device of claim 4, wherein the command assembling unit is configured to generate the second type instruction data when a bit count of the received set of instruction signals is higher than the predetermined number.

7. The memory device of claim 1, wherein the address and command inputs are configured to receive one of at least a complete set of instructional signals for the first type instruction data in one clock cycle and at most half of the instruction signals for a second type instruction data in one clock cycle.

8. The memory device of claim 1, wherein the command assembling unit generates the second type instruction data by combining the plurality of sets of instruction signals.

9. A memory module, comprising:
a memory controller;
a plurality of memory devices; and
one or more address and command buses connected between the memory controller and the plurality of memory devices,
wherein each memory device comprises:
a memory array;
an instruction unit for receiving instruction data and performing a memory related operation depending on the instruction data;
address and command inputs for receiving instruction signals from the memory controller via the address and command bus;
a reception unit adapted to receive sets of instruction signals in successive clock cycles; and
a command assembling unit adapted to selectively generate a first type instruction data from a single set of instruction signals received in a single clock cycle and a second type instruction data from a plurality of sets of instruction signals received in a corresponding plurality of successive clock cycles and to provide the first type instruction data and the second type instruction data to the instruction unit.

10. The memory module of claim 9, wherein the plurality of memory devices comprises a first group of memory devices and a second group of memory devices, wherein each group includes a separate group of address and command inputs connected respectively to one of the one or more address and command bus.

11. The memory module of claim 10, wherein each address and command bus includes a number of address and command lines corresponding to one of at least a complete set of instructional signals for the first type instruction data in one clock cycle and at most half of the instruction signals for a second type instruction data in one clock cycle.

12. The memory module of claim 9, wherein the memory array is a DRAM memory array arranged in a word-line/bit-line matrix and wherein the first type instruction data includes a pre-charge instruction and wherein the second type instruction data includes one of a word line activation command and a bit line activation command.

13. The memory module of claim 9, wherein the address and command inputs comprise differential inputs.

14. The memory module of claim 9, wherein the command assembling unit is configured to generate the first type instruction data when a bit count of the received set of instruction signals is less than a predetermined number corresponding to a number of address and command lines of the address and command bus.

15. The memory module of claim 9, wherein the command assembling unit generates the second type instruction data by combining the plurality of sets of instruction signals.

16. A method for supplying instruction data to an instruction unit in a memory device, wherein an operation related to a memory array of the memory device is performed based on the received instruction data, comprising:
receiving a first set of instruction signals in a first clock cycle; and
when the first set of instruction signals received is a complete set of instruction signals, generating a first type instruction data from the first set of instruction signals received in the first cycle and providing the first type instruction data to the instruction unit; and
when the first set of instruction signals received is not a complete set of instruction signals, receiving one or more successive sets of instruction signals in one or more successive clock cycles and generating a second type instruction data from the first and the one or more successive sets of instruction signals received in the first and the one or more successive clock cycles and providing the second type instruction data to the instruction unit.

17. The method of claim 16, further comprising:
defining a predetermined number corresponding to a number of address and command lines, wherein the predetermined number is greater than a bit count of a complete set of instruction signals for the first type instruction data, and wherein the first type instruction data is generated when a bit count of the received set of instruction signals is less than the predetermined number.

18. The method of claim 16, wherein the memory device is a dynamic random access memory having a memory array arranged in a word-line/bit-line matrix, wherein the first type instruction data include a pre-charge instruction and wherein the second type instruction data include one of a row activation command and a column activation command.

19. The method of claim 16, further comprising:
transmitting the instruction signals as differential signals on differential lines from a memory controller to an address and command interface of the memory device.

20. The method of claim 16, wherein the memory device is configured to receive one of at least a complete set of instructional signals for the first type instruction data in one clock cycle and at most half of the instructional signals for a second type instruction data in one clock cycle.

21. The method of claim 16, wherein the second type instruction data is generated by combining the first and the one or more successive sets of instruction signals.
